(19) United States
(12) Patent Application Publication
(10) Pub. No.: US 2023/0177434 A1
(43) Pub. Date: Jun. 8, 2023

(54) METHOD AND SYSTEM FOR ROUTING RISK MITIGATION DURING TRANSPORTATION OF GOODS

(71) Applicant: Genpact Luxembourg S.à r.l. II, Lumbourg (LU)

(72) Inventor: David I. Hauser, Merrick, NY (US)

(21) Appl. No.: 17/540,969

(22) Filed: Dec. 2, 2021

(51) Int. Cl. G06Q 10/06; G06Q 10/08

(52) U.S. Cl. CPC G06Q 10/0635; G06Q 10/0838; G06Q 10/06315; G06Q 10/06393

(57) ABSTRACT

A method for mitigating routing risks during transport of goods is provided. In some embodiments, the method includes obtaining historical records for transported goods, where the records include routes with associated road segments. The method also includes establishing risk metrics for each road segment on each route based on the historical records and calculating, from the risk metrics, road risk and road probability metrics for each road segment on each route. The method further includes applying a weight to each of the road risk and road probability metrics, combining, for each road segment, the weighted road risk and road probability metrics for such road segment into a composite risk score (CRS) that defines whether such road segment is low-risk or high-risk for transporting goods, and selectively adjusting a length of each road segment defined as low-risk and/or each road segment defined as high-risk based on their corresponding CRS.

### TECHNICAL FIELD

This disclosure relates to a method and system using machine learning, artificial intelligence, or other types of modeling to provide low risk routing options for commercial transportation of goods.

### BACKGROUND

Companies write-off large amounts of inventory every year for a variety of reasons such market share shrinkage, expiration, decreasing consumer demand, increasing costs to carry, and damage incurred during transport. The specific issue of damage during transport is unique among all the drivers of write-offs since the damage may occur before the business takes possession of the product, while the goods are in possession by the business, or once a customer takes possession. There are well-established processes for handling these damages from an accounting perspective, such as filing claims with the supplier, filing insurance claims, selling at deep discount, repairing and reselling, etc.

One source of damage in particular relates to shipping. When goods are damaged while in transit, liability for the damage is handled via agreement and corresponding accounting principles. Accounting aside, the retailer will not get all the goods ordered as some are damaged. Consequently, the retailer may not be able to meet demand. Whether insurance pays for the damaged goods, the carrier pays for it, the vendor pays for it, or the retailer pays for it, it impacts the customer through some means, such as higher costs of doing business, some damage is not recognized in advance and thus damaged goods could be given to customers, etc. Thus, all parties have a stake in preventing the damage from occurring in transit. Current processes for transportation companies to reduce the probability of damage in transit include product cushioning (e.g., bubble wrap, Styrofoam, and the like), product securing (e.g., strapping boxes into place, shrink wrapping pallets, and the like), and driver training. Yet, despite these precautions, damage in transit still occurs.

### SUMMARY

To address the aforementioned shortcomings, a method and system for routing risk mitigation during the transportation of goods is proposed. According to some embodiments, there are two components to the proposed method. According to some embodiments, the first component determines the route risk based on historical data on claims of damage in transit. For example, an algorithm looks across all the claims and establishes common features—e.g., which road segments were common across many different damage claims. According to some embodiments, the second component takes two inputs: the points of origin and destination, and the risk associated with each route between them. Subsequently, the algorithm applies a weight to each route segment, with the weight being inversely proportional to the risk associated with the specific road segment. In one variation, an algorithm “penalizes” a high-risk segment of a route by mathematically expanding the length of the high-risk segment. Consequently, the high-risk segment appears longer than lower-risk segments, and for this reason, it would be less likely to appear as an option in a routing application. In another variation, an algorithm “rewards” a low-risk segment of route by mathematically shrinking its length. Consequently, the low-risk segments appear shorter (and more appealing) than higher-risk segments, and thus, it would be more likely to appear as an option in a routing application. In some embodiments, the algorithm also takes into account the risk associated with the points of entry and exit in a route segment as the entry and exit points may influence the risk profile of the route segment.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIGS. 1A and 1B show a flow chart of a method for mitigating routing risks during transport of goods, according to some embodiments.

FIG. 2 shows imported data from a single route record over a range of dates in tabular form, according to some embodiments.

FIGS. 3 and 4 show high-level logic processes used by a Risk Assessment Algorithm (RAA), according to some embodiments.

FIG. 5 is a system that can be used in a method for mitigating routing risks during transport of goods, according to some embodiments.

### DETAILED DESCRIPTION

The Figures (Figs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Underlying Data

It is often the case that retailers receiving goods, manufacturers shipping goods, and transporters transporting goods maintain records with historical data related to the transport of goods. By way of example and not limitation, such records may include data related to the date, time and duration of travel; origin, destination, and route details; list of goods being transported; the dollar value of goods in transit; equipment details used for the transport of goods, etc. When the goods arrive at their intended destination, they are inspected and if damaged, the receiver files a claim with the manufacturer, the transporter, or the insurance company depending on what the contract agreement may be. Therefore, all the parties involved (e.g., the stakeholders) are aware which goods are damaged and what is the dollar value of the damaged goods.

Based on the claim information accumulated over time, the records are updated accordingly. Therefore, a historic transport record from a retailer, a manufacturer, or a transporter would, at a minimum, contain the following information: dates, routes, value of goods transported, value of damaged goods, types of goods transported, types of goods damaged. According to some embodiments, a Risk Assessment Algorithm (RAA) uses these records to determine the risk associated with the route taken for each trip.

### Risk Assessment Algorithm

According to some embodiments, the RAA compares shipments with damage and shipments without damage to determine a risk associated with each route used in the shipments. In some embodiments, if there is a claim for a damage of $1,000, all segments of the route traveled on that transportation claim are allocated the $1,000. For instance, if the shipment with the damage travelled on a route with five road segments A, B, C, D, and E, all five road segments will be taxed with $1,000 in their accounting. If another claim for $500 of damage was made for a trip on road segments A and B, then these two road segments will get $500 added to their accounting. Consequently, the total accounting for road segments A and B is at $1,500, while the total accounting for road segments C, D, and E remain at $1,000. Perhaps there is another claim for $2,000 damage on road segments A and E. Therefore, these two road segments get $2,000 added to their accounting and the total accounting for each road segment becomes: A equal to $3,500, B equal to $1,500, C and D equal to $1,000, and E equal to $3,000. Since road segment A has accumulated over time the highest total accounting, it is also determined that road segment A has the highest damage profile.

According to some embodiments, the RAA not only tracks the dollar damage for each road segment, but also tracks non-damage road segments. For example, assuming that a $10,000 shipment is transported on road segments A and B without any reported damages, each of these two road segments is awarded $10,000 in non-damage accounting.

According to some embodiments, the above sums and other standard or user-specific key performance indicators (KPIs) (e.g., the number of travels on each road segment, the number of travels with damage, percentage of travels with damage, the total value of goods, the value of damaged goods, etc.) are used to derive odds ratios of risk that provide a probability of damage. In some embodiments, odds ratios are expressed as ratios of a “bad outcome” divided by a “good outcome”—for example, the number of units damaged divided by the number of units not damaged, the value of goods damaged divided by the value of good not damaged, and the like. Theses odds ratios and the standard or customized key performance indicators (KPIs) are tracked by route and road segment to establish seasonality (e.g., the presence of variations that occur at specific regular intervals), patterns, statistical significance, and other important metrics.

In some embodiments, a “time” weight can be applied to selected KPIs and metrics. For example, in the example presented above, all the KPIs/metrics (and the odds ratios derived therefrom) are equally weighted with respect to when the damage occurred. For example, a damage that occurred yesterday is assumed to have an equal importance with a damage that occurred last year. When a time weight is applied, the older the damage, the lower the weight and vice versa. Therefore, in the example provided above, a trip yesterday gets the full dollar amount allocation, while a trip from last year gets only a fraction of the full dollar amount allocation. The discount grows as the record ages according to some embodiments. In some embodiments, the time weighting can be a linear progression from 100% for a damage that occurred today to, for example, 0% for a damage that occurred two years ago.

In some embodiments, the length of time at which the time weight is equal to zero can be arbitrary and selected by the user (e.g., a fleet operator, the insurance company, etc.). However, a default range may be selected for a two-year period. The linear progression can also be changed to non-linear—in which case it can be either monotonic or non-monotonic.

More complicated scenarios are also possible and within the spirit and the scope of this disclosure. For instance, when the historical date is similar to the current date, the weight is closer to 100% and when the historical date is dissimilar to the current date, the weight can be close to zero. More specifically, if traveling on a Saturday in June, all past Junes and all past Saturdays can have a weight of 100%, whereas all other dates can have a linear progression from 100% to 0% over a two-year period.

### Risk Calculation

In some embodiments, Road Risk metrics are obtained by considering all the non-weighted and weighted KPIs and metrics (as defined above) to calculated respective weighted and non-weighted odds ratios for each road segment. All these (e.g., the weighted and non-weighted KPIs, various metrics, and odds ratios) are forms of Road Risk—i.e., Road Risk metrics. In addition to the above, Road Popularity is also quantified by considering “volume” KPIs for each road segments, such as the total number of travels per road, the total value of products in dollars transported per road, etc. Furthermore, volume odds ratios are calculated based on the volume KPIs. Each of these volume KPIs and respective odds ratios are forms of Road Popularity—i.e., Road Popularity metrics.

Subsequently, a weight is applied to each Road Risk metric and each Road Popularity metric. In some embodiments, the weight is adjustable and can be set to a desirable value by the user (e.g., the fleet manager, etc.). In some embodiments, the weight for each metric is set to a default value if the user does make an election. However, when the user makes a weight value election, he or she needs to determine which of the many different metrics are most important since the weight election will bias the outcome. In the simplest case, all metrics are equally weighted; however, this may not yield optimum results.

In some embodiments, the weights can be independently derived by a Machine Learning (ML) model. For example, an ML model can be trained to estimate the weight for the above-noted metrics so that the driving distance for a route is optimized while high risk roads and low usage roads (e.g., backroads) are avoided. if an ML model is not used, the optimization may be performed by the user.

Once the weights have been applied to each metric, all the metrics for each road segment are combined to arrive at a single Composite Risk Score (CRS) for each road segment. Subsequently, the roads are divided based on CRS into quintiles, deciles, or at any suitable division from high risk to low risk. Because some roads are two-way roads, there is distinction in the CRS based on the direction of travel. For example, a northbound travel on a segment of road could have a different CRS than a southbound segment on the same road.

### Route Determining

Traditional global positioning systems (GPS) solve a variant of the traveling salesman problem (e.g., minimize travel time) by taking the distance of each road segment and multiply it by the speed limit to convert road lengths into travel times. The results are then scaled based on traffic conditions. For example, no traffic means on a road segment means that the travel time on that road segment is not scaled (or multiplied by one), whereas moderate or heavy traffic is scaled by a value greater than 1. A road closure may be scaled to a very high value or infinity. Variations of the traffic incorporation use estimates of the speed of travel which is multiplied by the length of the road segment to get the travel time.

On the other hand, the method disclosed herein (e.g., the “CRS version” of the GPS) scales the travel times (e.g., the road length times the travel speed) by the normalized CRS to derive a new “travel time” for each road segment. In some embodiments, the method disclosed herein uses three fundamental scoring methods, each with several variations.

The first fundamental approach is to Penalize High Risk Roads (PHRR). In this approach road segments with low CRS are assigned a scalar of 1 while road segments with high CRS are assigned a scalar that is greater than 1—for example, orders of magnitude greater. Consequently, when the travel times are scaled based on this approach, the routing algorithm “thinks” that high-risk road segments are much longer than the low-risk road segments. Therefore, when the routing algorithm tries to find the shortest route to minimize travel time, it inadvertently options for the least risky routes.

In some embodiments, the maximum scalar for the highest-risk road is a ratio of the longest actual travel time of any complete road segment divided by the shortest actual travel time of any complete road segment. For instance, if the longest road segment corresponds to a 30 minutes of travel time and the shortest road segment corresponds to 0.5 minutes of travel time, the maximum scalar for the highest risk road is 60. Consequently, the road lengths scale based on risk, with the highest-risk road segment being scaled at 60×. However, this is not limiting, and the maximum scalar for the highest-risk road can be arbitrarily selected by the user (e.g., the fleet manager)—e.g., at a much higher or a much lower value. It is noted however that the higher the maximum scalar, the more the routing algorithm works to avoid high (and moderate) risk roads. For example, if the maximum scalar is 100, 1000, or higher, high-risk roads will appear hundreds of times longer than they actually are and less likely to be selected by the routing algorithm. In such situations, the routing algorithm will select routes on backroads and other unrealistic paths. Therefore, to keep the maximum scalar to a more reasonable level, selecting the ratio of max length/min length is an acceptable compromise.

The second fundamental approach is Reward Low Risk Roads (RLRR). This approach works in reverse from PHRR. Rather than scale high-risk roads very high, the high-risk roads are scaled to 1 and the low-risk roads are scaled with a multiplier less than 1 (e.g., <1) so that a low-risk road segment will appear to be shorter than it actually is. Hence, the upper limit for a high-risk road segment is 1 and the lower limit is the ratio of the minimum travel time of all road segments divided by the maximum travel time of all road segments (e.g., the inverse of the upper limit ration of the PHRR algorithm). However, this is not limiting and a user may select the lower limit to be any value less than 1 and equal to or greater than 0.

The third fundamental approach is to Sever High Risk Roads. The RLRR and PHRR are still able to use any road segment for routing a vehicle—i.e., the penalized or non-rewarded road segments are still available as a travel option. For instance, perhaps a destination is on one of the high-risk road segments. In such a case, the destination road segment cannot be excluded. In other words, RLRR and PHRR are like a traffic algorithm, they still consider all road segments for determining a path and only re-route when required. In the Sever High Risk Roads (SHRR) approach, any road segment whose CRS is above a threshold, such as the mean value of risk across all road segments (e.g., the average risk across all road segments) plus one or two standard deviations, is scaled by an arbitrarily large value (e.g., 1,000,000). This makes this road segment a million times longer to travel on, which effectively severs that road segment from consideration. However, if that road segment is the only way to get to a store, the routing algorithm will still present it as a routing option at a cost of 1,000,000 times longer travel time. It is noted that the aforementioned mean value of risk can refer to a mean value under similar filtering options such as the day of the week, the month of the year, and the like.

According to some embodiments, once all road travel times are scaled accordingly to the methods described above, the standard shortest distance algorithms are applied. Subsequently, the actual travel times are reported on the suggested routes. In other words, the artificially inflated or deflated travel times described above are used internally in the backend by the routing algorithm to make a route selection. However, once the route selection has been made by the routing algorithm, a driver will only see the proposed route option and the actual travel time for this route.

### Method for Routing Risk Mitigation

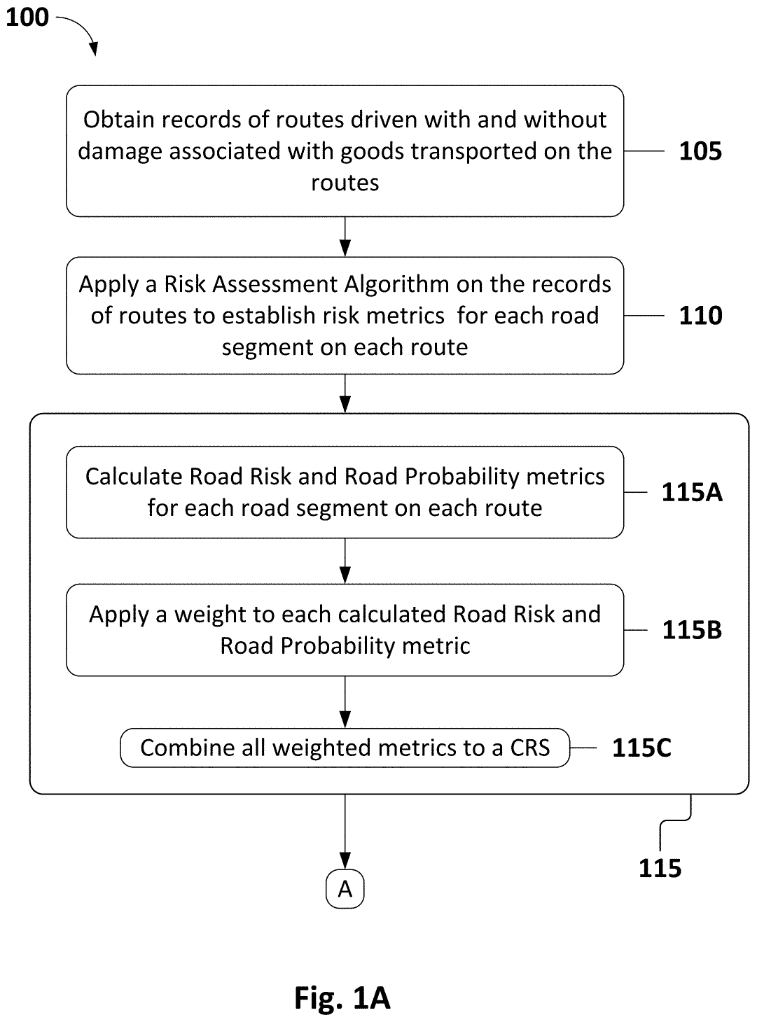

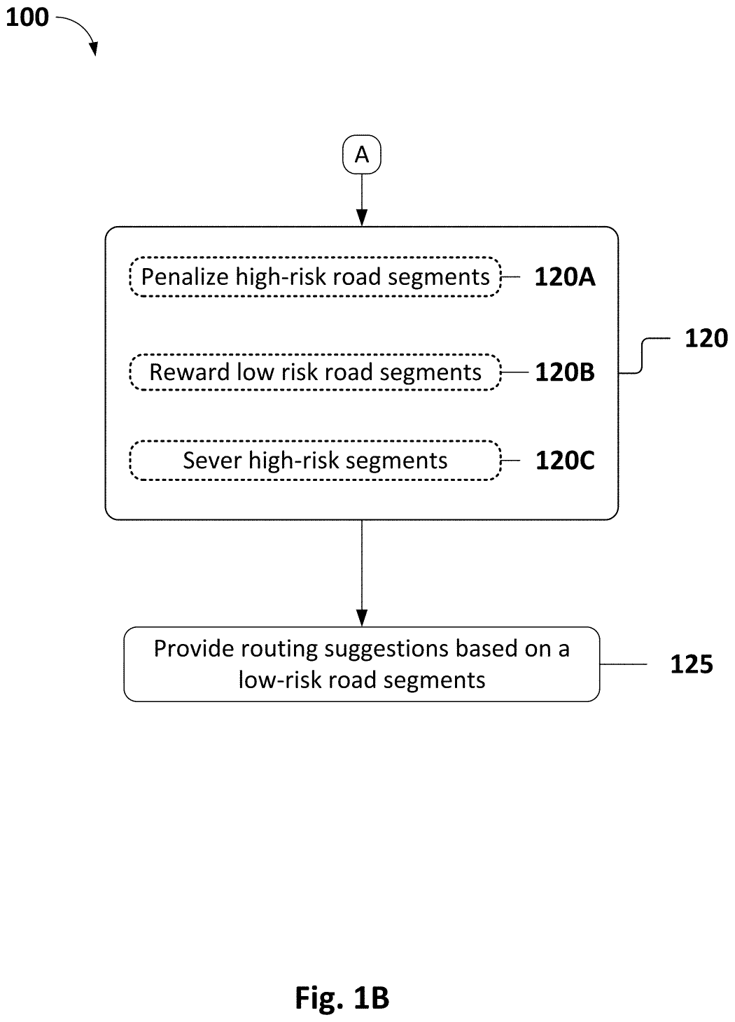

According to some embodiments, FIGS. 1A and 1B show a flow chart of a method 100 for routing risk mitigation during the transportation of goods. Other operations may be performed between the various operations of method 100 and may be omitted merely for clarity. This disclosure is not limited to this operational description. It is to be appreciated that additional operations may be performed. Moreover, not all operations may be needed to perform the disclosure provided herein. Additionally, some of the operations may be performed simultaneously, or in a different order than that shown in FIGS. 1A and 1B. In some embodiments, one or more other operations may be performed in addition to or in place of the presently described operations.

In referring to FIG. 1, method 100 begins with operation 105 where route records are obtained. As discussed above, these route records should contain historical data for routes driven during the transportation of goods and may be obtained from a variety of sources including, but not limited to, retailers receiving goods, manufacturers shipping goods, transporters transporting goods, insurance companies receiving and handling claims related to damaged goods during transport, etc. In some embodiments, the route records may include route information from multiple retailers, multiple manufacturers, etc. In any event, such route records should include, at a minimum, dates for the trips, route taken for each trip, total value of goods transported, value of damaged goods, types of goods transported, types of goods damaged, and quantity of good damaged.

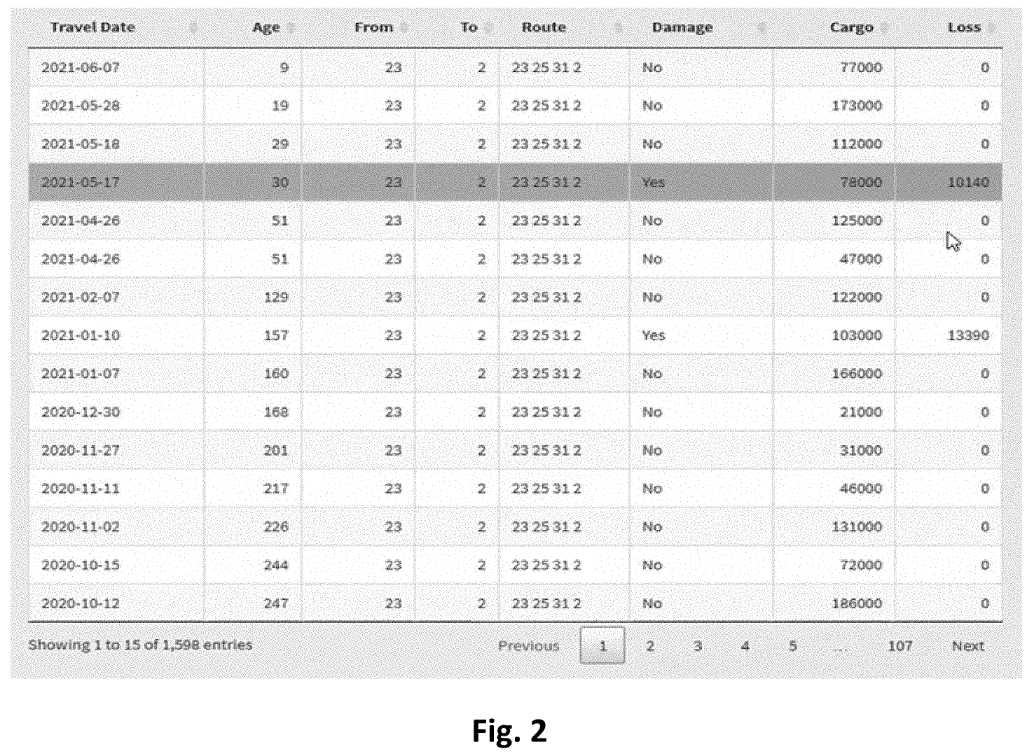

By way of example and not limitation, FIG. 2 shows imported data from a single route record (e.g., a route with road segments 23, 25, 31, and 2) over a range of dates in tabular form. In the example shown in FIG. 2, the information included are the Travel Date, how many days prior to the current date the trip occurred (Age), the origin and destination points of the route (From and To columns), the route path followed (Route with road segments 23, 25, 31, and 2), whether there is damage reported for the route on a specific date, value of the shipment (Cargo), and value of the damage reported (Loss). Tables like the one shown in FIG. 2 are created for every route in the record.

Optionally, the route records may contain additional information relevant to the analysis. By way of example and not limitation, the route records may contain the type of transporter used (e.g., a box truck, delivery truck, 18-wheeler truck, refrigerator truck, etc.), the age of the truck, how were the goods secured on the truck, how were the goods packaged, specific weather conditions during the transport (e.g., heavy rain/snow, sleet, wind advisories, etc.), and the like.

There are some items of information that are not required to practice method 100. For example, such information may relate to the pavement condition of the road segments used in each route, whether there were construction sites along the route or accidents. This is because these conditions are considered transient with limited statistical significance. In addition, such conditions may be challenging to record, obtain, and maintain for every road segment in routes covering hundreds, thousands, or even millions of miles. However, if such information is available, it may be used in method 100.

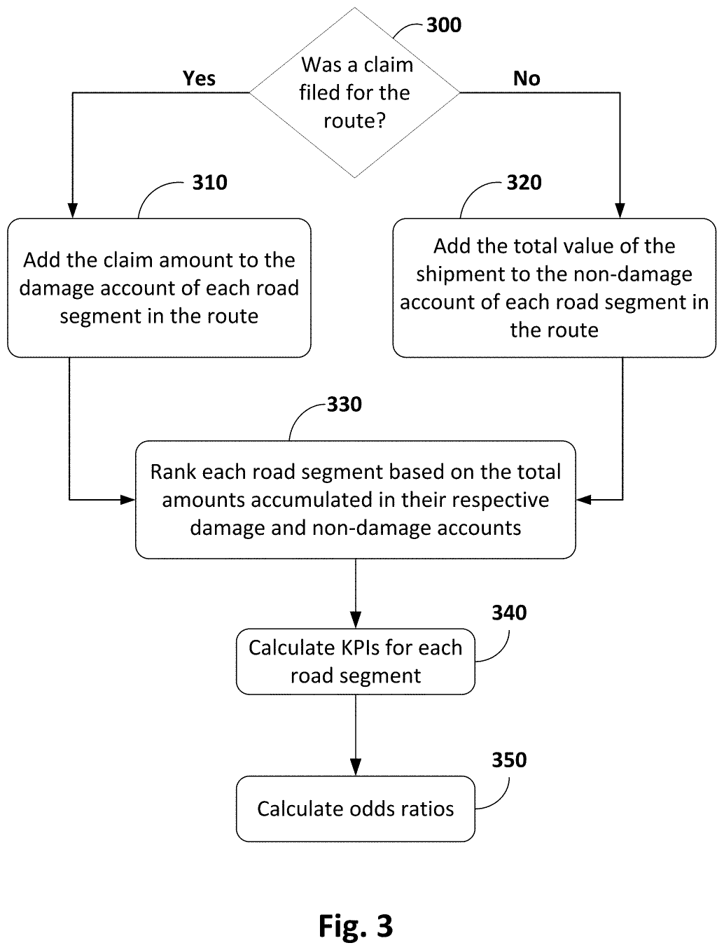

In referring to FIG. 1A, method 100 continues with operation 110 where the records are analyzed by an RAA. As discussed above, the RAA establishes risk metrics for each road segment on each route. According to some embodiments, a high-level logic process used by the RAA is shown in the flow chart of FIG. 3. The RAA starts by comparing shipments with damage and shipments without damage to determine a risk associated with each route used in the shipments. According to FIG. 3, the RAA inspects each route and identifies whether a claim was filed for that route (operation 300). If a claim is indeed filed for a route, the claimed amount is charged (e.g., taxed) to each road segment of the route in a corresponding “damage account” as shown in operation 310. For instance, if the shipment with the damage travelled on a route with five road segments A, B, C, D, and E, all five road segments will be taxed with $1,000 in their respective damage accounts. This is because, in most cases, it is impossible to assess on which road segment of the route the damage has occurred.

On the other hand, if there is no claim for a route, the total value of the shipment is added (e.g., rewarded) to a non-damage account of each road segment in the route as shown in FIG. 320. For example, assuming that a $10,000 shipment is transported on road segments A and B without any reported damages, each of these two road segments is awarded $10,000 in their respective non-damage accounts.

According to some embodiments, the above process (e.g., operations 300, 310, and 320) is executed for every combination of dates and routes in the record. As a result, there may be instances (e.g., dates) where a route has one or more claims and other instances (e.g., dates) where the route is claim-free. Consequently, a road segment on that route may have both charges and rewards in its damage and non-damage accounts respectively. Further, some road segments may be common between routes, and some road segments may be unique to a route. Therefore, charged or awarded amounts for each road segment may be the result of numerous combinations and permutations of different routes on different dates over long periods of time.

In some embodiments, and once the above process is complete, the RAA ranks each road segment based on the total amounts accumulated in their respective damage and non-damage accounts as shown in operation 330. For example, road segments with high activity in their damage accounts (e.g., with high totals) are considered more risky than road segments with lower activity (e.g., with lower totals). On the other hand, road segments with high activity in their non-damage accounts (e.g., with high totals) are consider less risky or safer than road segment with lower activity (e.g., with lower totals). Thus, after the above process, a preliminary risk assessment ranking for each route is made and an initial list with the most risky to the least risky road segments is created.

Subsequently, the RAA continues by tracking (e.g., calculating) standardized and user-specific KPIs over time for each road segment as shown in operation 340. By way of example and not limitation, KPIs may include, but are not limited to travels with damage, percentage of travels with damage, value of goods, value of damaged goods, damaged goods as a percentage of total value, and the like that can be found in standardized claim forms. It is to be understood that the above list of KPIs is exemplary and not exhaustive. Consequently, additional, fewer, or different KPIs from the ones provided above may be selected.

In some embodiments, the RAA does not select which KPIs or metrics to use for the subsequent calculations of the odds ratios discussed below. In other words, the RAA is configured to use any provided, pre-defined KPIs and/or metrics for the calculation of the odds ratios. The KPIs may be part of a default list, user-specific, or any combinations thereof.

Subsequently, the RAA uses the above KPIs and other suitable metrics, such as the sums and ranking information collected in operation 330, to calculate a plurality of odds ratios. In some embodiments, the odds ratios are designed to quantify the performance of each road segment in a route and assign a relative “damage probability”. As discussed above, odds ratios can be expressed as the ratio of a bad outcome (e.g., attributed to damage) divided by a good outcome (e.g., attributed to non-damage). Examples of odds ratios include, but are not limited to, the number of units damaged divided by the number of units not damaged, the value of goods damaged divided by the value of goods not damaged, or any suitable damage to non-damage ratio.

In some embodiments, a default list of KPIs is automatically calculated. In some embodiments, users may select which KPIs are calculated from a default list of KPIs. In some embodiments, users may modify existing KPIs or add their own based on the data available in the record. Therefore, any possible combinations and permutations of KPIs are within the spirit and the scope of this disclosure.

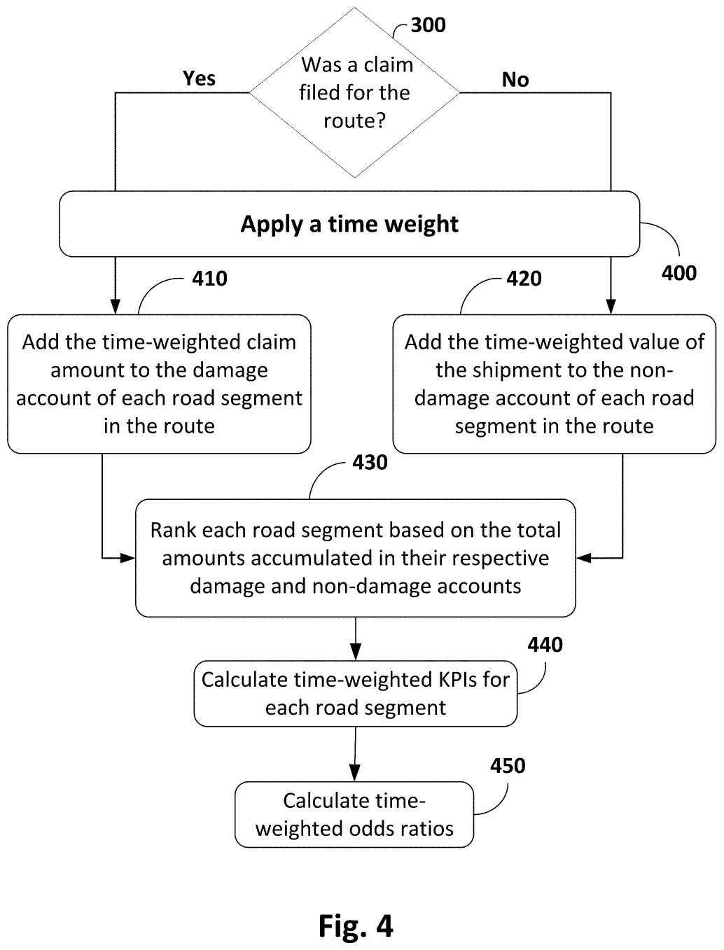

In the flow chart shown in FIG. 3, all the KPIs, metrics, and the odds ratios derived therefrom are equally weighted with respect to when a trip with damage or a damage-free trip occurred. For example, a damage incident or a damage-free trip that occurred today is assumed to have an equal importance with a damage incident or a damage-free trip that occurred last year or the year before. In some embodiments, FIG. 4 shows a variation of the flow chart shown in FIG. 3 that includes an additional operation 400 after operation 300 and prior to modified operations 310 and 320, which are labeled as operations 410 and 420 respectively in FIG. 4. In the example of FIG. 4, a time weight is applied to the amounts taxed and rewarder in operations 410 (modified operation 310) and 420 (modified operation 320) respectively.

For example, the time weight can be defined based on the number of days passed from when the damage incident occurred or form when the damage-free trip occurred, as indicated by the column labeled “Age” in FIG. 2. For example, when a time weight is applied, the greater the number of days that passed since the date of the damage incident or the damage-free trip, the lower the weight (e.g., lessens the importance). Accordingly, the fewer the number of days that passed since the date of the damage incident or the damage-free trip, the higher the weight (e.g., increases the importance). Therefore, in operations 410 and 420 (depending on what the case may be according to operation 300), a trip yesterday gets taxed or rewarded the full dollar amount, while a trip from last year gets taxed or rewarded an adjusted dollar amount (e.g., a time weighted amount). In other words, in operation 410, each road segment is taxed a time-weighted claim amount to its respective damage account, while in operation 420, each road segment is awarded a time-weighted value of the shipment in its respective non-damage account.

In some embodiments, the weight value reduces as the record ages. By way of example and not limitation, the time weight value can be configured, if desired, to reduce linearly from 100% for a damage incident that occurred today to 0% for a damage incident that occurred two years ago. In some embodiments, the length of time at which the time weight is equal to zero can be arbitrarily selected by the user (e.g., a fleet operator, the insurance company, etc.). Alternatively, a default range may be selected for a two-year period. The linear progression can also be changed to non-linear—in which case it can be either monotonic or non-monotonic. According to some embodiments, all possible combinations and permutations are within the spirit and the scope of this disclosure.

According to some embodiments, more complicated scenarios are also possible and within the spirit and the scope of this disclosure. For instance, when the date of the damage incident (e.g., the historical date) is similar to the current date, the weight is closer to 100% and when the historical date is dissimilar to the current date, the weight can be close to zero. By way of example and not limitation, if traveling on a Saturday in June, all past Junes and all past Saturdays can have a weight of 100%, whereas all other dates can have a linear progression from 100% to 0% over a two-year period. According to some embodiments, all possible combinations and permutations are within the spirit and the scope of this disclosure.

It is noted that the only difference between operations 310/320 and their modified counterparts (e.g., operations 410/420), is that in operations 310 and 320 each road segments is taxed or rewarded 100% of the appropriate dollar amount regardless of the event age, while in operations 410 and 420, each road segments is taxed or rewarded a time-weighted (e.g., pro-rated or adjusted) dollar amount between 100% and 0% based on the event age.

It is to be understood that the time weight concept described above is not limited to the examples provided in reference to operations 410 and 420. Instead, the time weight concept may be applied to any suitable KPI or metric. For example, KPIs and metrics can have an assigned weight based on when the recorded incident occurred in time. KPIs and metrics for recent events are more weighted (e.g., have a higher weight value) than the same KPIs and metrics for older events. Subsequently, the odds ratios calculated from these KPIs and metrics would inherit the time weights assigned to the KPIs and metrics from which they originate.

In some embodiments, the RAA may analyze the data and track KPIs and metrics by the time of day (if provided), by day of the week, by week, by month, by quarter, by year, or any combinations thereof to identify correlations and trends. For example, by tracking KPIs, metrics, and odds ratios for all the days of the week for any extended amount of time (e.g., a year, two years, three years, etc.), the RAA may find that for some reason Tuesdays have more damage reported than Thursdays, or perhaps that weekends have fewer reported damages, or that Junes are less risky than Septembers, or that transports during the first quarter of the year are typically less risky than transports during the third quarter of the year, etc. Therefore, a plurality of odds ratios may need to be calculated to allow filtering at the granularity levels described above.

In some embodiments, operations 430, 440, and 450 in FIG. 4 are executed the same way as in FIG. 3 with the only difference being that the metrics and KPIs tracked are now time-weighted and the calculated odds ratios derived from them are also time-weighted.

In some embodiments, the RAA may track a combination of time-weighted and non-weighted KPIs, and odds ratios. Consequently, the RAA executes the operations shown both in FIG. 3 and FIG. 4. In such case, the KPIs (and odds ratios derived therefrom) in FIGS. 3 and 4 are different—for example, the RAA does not provide a weighted and non-weighted version of the same KPIs and odds ratios. In other words, the KPIs and odds ratios in FIGS. 3 and 4 are complimentary to each other. In some embodiments, the RAA tracks only non-weighted KPIs and odds ratios, and therefore, executes only the operations shown in FIG. 3. In some embodiments, the RAA tracks only time-weighted KPIs and odds ratios, and therefore, executes only the operations shown in FIG. 4. In some embodiments, any combination or permutation of KPIs and odds ratios derived therefrom from FIGS. 3 and 4 are within the spirit and the scope of this disclosure.

In referring back to FIG. 1A, method 100 continues with operation 115, which describes the Risk Calculation process. According to some embodiments, operation 115 includes sub-operations 115A, 115B, and 115C. As discussed above, Risk Calculation includes calculating Road Risk and Probability metrics for each road segment on each route (sub-operation 115A), applying a weight to each calculated Road Risk and Probability metrics (sub-operation 115B), and combining all the weighted metrics calculated above to a CRS (sub-operation 115C).

In some embodiments, Road Risk is calculated by considering all the various time-weighted and non-weighted KPIs for each road segment and calculating all the various probability ratios (time-weighted or non-weighted). As discussed above, Road Risk metrics are calculated at least in part during operation 110. However, additional time-weighted and non-weighted metrics can be calculated in operation 115A, such as percent of travel that has damage, percent of volume of goods with damage, percent of dollars transported that had damage, etc.

In addition to the above, Road Popularity is also quantified by considering “volume” KPIs and metrics for each road segments, such as the total number of travels per road, the total value of products in dollars transported per road, etc. Volume KPIs and metrics reveal the relationship between road popularity and risk. For example, perhaps two road segments with similar popularity are having different associated risks, and therefore, it would be in the best interest of a fleet manager to request that the riskier road segment is avoided when a route is calculated. Subsequently, volume odds ratios are calculated based on the volume KPIs and metrics. The volume KPIs, metrics, and odds ratios are forms of Road Popularity and define Road Popularity metrics.

Once the Road Risk and Road Probability metrics have been calculated, a weight is applied to each Road Risk metric and Road Popularity metric (referred to thereafter as “metrics” for simplicity) according to sub-operation 115B. In some embodiments, the weights are user defined or set to a default value if no election is made by the user. In some embodiments, weights are defined based on the importance of the metric to be weighted. For example, metrics higher in importance tend to be weighted more heavily that metrics lower in importance. In the simplest case, all metrics are equally weighted; however, this may not yield optimum results. In some embodiments, the metric importance is relative and it is determined by the type of products being transported. For example, for the transportation of soft/cushioned products like mattresses and pillows, minor risks like a bouncy road segment may not be a concern, while road segments with extremely high dollar value losses may be more important. On the other hand, transportation of glass products may be quite different than the transportation of soft/cushioned products. Therefore, determination of the metric importance may vary between product industries.

In some embodiments, the weights can be independently derived with the help of an ML model. For example, an ML model can be trained to estimate the weight of each metric so that the driving distance for a route is optimized while high risk roads and low usage roads (e.g., backroads) are avoided. Training the ML model, however, requires availability of training data and test data. Once the ML model is trained, it can work on new (e.g., fresh) data to estimate the weights for the Road Risk and Road Probability metrics.

Deriving the weights for Road Risk and Road Probability metrics in operation 115C is not limited to the examples presented above, and other appropriate methods, not disclosed herein merely for brevity, may be used. These other appropriate methods are within the spirit and scope of this disclosure.

Once the weights have been defined and applied to each metric, the weighted metrics for each road segment are combined to arrive at a CRS for each road segment according to operation 115C. In some embodiments, the CRS for each road segment is calculated as a linear combination of different weighted ratios. Based on their CRS values, the road segments are divided into quintiles (e.g., deciles) of CRS from high risk to low risk. It is noted that because some roads are two-way roads, there is distinction in the CRS based on the direction of travel. In other words, the Road Risk and Road Probability metrics and the corresponding CRS values are generated for both directions of travel in two-way road segments. For example, a northbound travel on a segment of road could have a different CRS than a southbound segment on the same road. Consequently, one direction of travel may be preferred over the other during a route calculation.

According to some embodiments, sub-operation 115C concludes operation 150 and the Risk Calculation process.

In referring to FIG. 1B, method 100 proceeds to operation 120 where the determination of the route occurs. According to some embodiments, operation 120 includes any of the following scoring methods: scoring method 120A referred to as Penalize High Risk Roads (PHRR), scoring method 120B referred to as Reward Low Risk Roads (RLRR), and scoring method 120C referred to as Sever High Risk Roads (SHRR). That is to say, any of the aforementioned scoring methods can be used to determine the route by method 100. According to some embodiments, scoring methods 120A, 120B, and 120C are distinct from each other on their approach to determine a route.

In PHRR (scoring method 120A), high-risk road segments are selectively penalized. More specifically, road segments with low CRS are assigned a scalar equal to 1 (e.g., no scaling), while road segments with high CRS are assigned a scalar greater than 1 (e.g., scaling). Consequently, when the travel times are scaled based on this approach, the routing algorithm “thinks” that high-risk road segments are physically longer than their low-risk counterparts. Therefore, when the routing algorithm tries to find the shortest route to minimize travel time, it inadvertently favors the least risky road segments because riskier road segments appear physically elongated (e.g., artificially longer), which is a less attractive option. This means, that the routing algorithm only “sees” scaled lengths for the high-risk road segments and not their actual physical lengths.

In some embodiments, the user may elect the CRS threshold value at which the scalar is set to be greater than 1 for the high-risk roads. In some embodiments, a CRS threshold value can be set to a default value, as discussed below, if the user does not make a prior selection. In some embodiments, the scalar value does not “jump” from 1 to the maximum scalar value for all the high-risk road segments; instead, it may gradually increase from high-risk roads to higher-risk roads at a predetermined rate. This predetermined rate may be linear or non-linear, according to some embodiments.

In some embodiments, the maximum scalar for the highest-risk road is set to a default value that is equal to the ratio of the longest actual travel time of any complete road segment divided by the shortest actual travel time of any complete road segment. For instance, if the longest road segment corresponds to a 30 minutes of travel time and the shortest road segment corresponds to 0.5 minutes of travel time, the maximum scalar for the highest risk road is 60. Consequently, the road lengths scale based on risk, with the highest-risk road segment being scaled at maximum scale value—e.g., 60× according to the example above. However, this is not limiting, and the maximum scalar for the highest-risk road can be arbitrarily selected by the user at any desired value.

According to some embodiments, the higher the maximum scalar, the more the routing algorithm works to avoid high (and moderate) risk roads. For example, if the maximum scalar is 100, 1000, or higher, high-risk roads will appear hundreds of times longer than they actually are and less likely to be selected by the routing algorithm. In these situations, the routing algorithm may select routes on backroads and other unrealistic paths. Therefore, setting the maximum scalar to a more reasonable level—e.g., selecting the ratio of max length/min length—is an acceptable compromise for most cases.

On the other hand, RLRR scoring method (operation 120B) follows a different approach from PHRR. For example, instead of penalizing the high-risk road segments by artificially elongating them (i.e., by applying a multiplier or scalar greater than 1), RLRR rewards low-risk road segments by shrinking them without scaling (e.g., penalizing) the high-risk roads. According to some embodiments, this is achieved by selectively scaling the low-risk road segments with a multiplier (e.g., a scalar) that is less than 1. In some embodiments, the high-risk roads are scaled close to 1, while the low-risk segments are selectively scaled with a multiplier less than 1 (e.g., <1).

In some embodiments, the minimum scalar (e.g., lower limit) that can be applied to a road segment is the ratio of the minimum (e.g., shortest) travel time of all road segments divided by the maximum (e.g., longest) travel time of all road segments (e.g., the inverse of the upper limit ratio of the PHRR algorithm). For instance, if the longest road segment corresponds to a 30 minutes of travel time and the shortest road segment corresponds to 0.5 minutes of travel time, the minimum scalar for the lowest risk road is equal to 0.017. However, this is not limiting and a user may select the minimum scalar to be less than 1 and equal to or greater than 0.

In some embodiments, the PHRR and RLRR approaches can be thought of as artificially adjusting the length of road segments or artificially adjusting the speed limit of road segments, much like traffic volume affects the travel time on road segments in a traditional GPS system. The RLRR and PHRR are still able to use any road segment for routing a truck, even if the proposed route have higher-risk road segments. This is because RLRR and PHRR are like a traffic algorithm, in that they can consider all road segments for determining a path and only re-route when required. For instance, perhaps a destination is on one of the high-risk road segments. In such a case, the destination road segment cannot be excluded.

In SHRR (scoring method 120C), a road segment whose CRS is above a threshold— e.g., the average CRS calculated across all road segments plus one or two standard deviations—it is scaled to an arbitrarily high number—e.g., 10, 100, 1000 times the maximum default scalar (e.g., the ratio of the longest actual travel time of any complete road segment divided by the shortest actual travel time of any complete road segment). According to some embodiments, the scaling in SHRR can be applied based on a range, CRS quantile division, a desirable tolerance value, or other appropriate criteria. Accordingly, SHRR makes the selected road segments to appear to the routing algorithm to be substantially longer to travel on (e.g., 10, 100, 1000, or 1,000,000 times longer), which effectively severs that road segment from consideration. However, if that road segment is the only way to get to the destination, the routing algorithm will still present it as a routing option at a cost of a significantly longer travel time.

According to some embodiments, any of the PHRR, RLRR, and SHRR, or any combinations thereof (e.g., a hybrid) may be selected for operation 120 of method 100. For example, a user may select to avoid high-risk road segments at all cost or be presented with a combination of some risky and less risky options to decide from. In some embodiments, all or a subset of the above methodologies (PHRR, PLRR, and SHRR) may be executed simultaneously and the resulting routes may be consolidated and presented as one or more routing options. In some embodiments, PHRR, RLRR, and SHRR may yield similar or different routing options depending on how the adjustable parameters in PHRR, RLRR, and SHRR are set (e.g., what are the max and min scalar values, what are the scaling rates for road segments with intermediate CRS values, etc.). Ultimately, each of PHRR, RLRR, and SHRR provide routing suggestions with a single goal, determine a path between the origin and destination with the lowest possible risk.

In referring to FIG. 1B, method 100 continues with operation 125 in which routing suggestions are provided based on low-risk road information. In some embodiments, the standard shortest distance and traffic information algorithms are applied once the low-risk road information is received and processed by a GPS unit. Once the standard shortest distance and traffic information algorithms are applied, the actual travel times are reported on the suggested routes to the end user (e.g., the truck driver). In some embodiments, method 100 results in a modification of the standard travel distance algorithm that determines a path (e.g., a route) with the lowest risk.

According to some embodiments, the routing options of method 100 are fed to a standard GPS unit for the application of the standard shortest distance and traffic information algorithms. In other words, the low-risk road information, much like the traffic information, can be fed wirelessly, e.g., from a server, to a GPS unit in the background without the knowledge of the end user (e.g., the truck driver). For example, the truck driver may only need to input the destination point to the GPS unit prior to getting routing suggestions based on low-risk road information.

### System Description

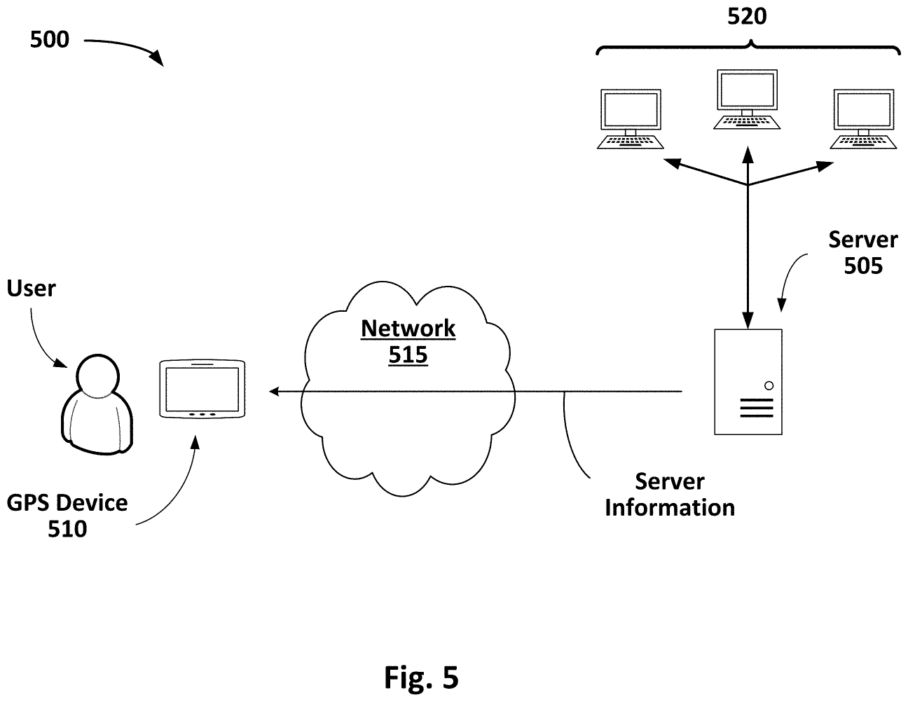

By way of example and not limitation, the operations of method 100 can be executed using an exemplary system 500 shown in FIG. 5. By way of example and not limitation, method 100 can be executed, at least in part, by a software application or software suite running on a remote server 505 communicatively coupled to one or more GPS devices (like GPS device 510) via a network 515. By way of example and not limitation, GPS device 510 can be a smart phone device, a tablet personal computer, or any suitable electronic device connected to network 515 and configured to run GPS navigation applications. In some embodiments, the software application running on remote server 505 operates without the knowledge or input from the user who operates GPS device 510. By way of example and not limitation, the user operating GPS device 510 can be a truck driver who is making a delivery of goods from an origin point to a destination point and seeks routing information from GPS device 510. By way of example and not limitation, network 208 can be a mobile network, a public network, or any suitable network that allows server 505 to communicate information to GPS device 510.

In some embodiments, server 505 is configured to store, process, and analyze historical data related to transport of goods received from a variety of sources such as retailers, manufacturers, transportation companies, insurance companies, other stakeholders, third parties, or combinations thereof. In some embodiments, server 505 includes hardware and software components that allow it to receive, process, and analyze information according to the operations of method 100 discussed above. By way of example and not limitation, server 505 can include databases for data storage and suitable regression models, ML models, natural language processing (NLP) models, or other models and algorithms configured to recognize, extract data, categorize data, analyze data, ingest data, re-format data, and fit data as required by the operations of method 100.

In some embodiments, server 505 is communicatively coupled to terminals of clients (e.g., businesses) 520 who oversee the transport of goods and may adjust, if they desire, aspects of method 100, such as provide weight suggestions for KPIs in sub-operation 115B of operation 115, provide max and minimum scaling factors for road segments in operation 120, and the like. In some embodiments, the software application responsible for executing method 100 on server 505 is a web-based application available as a cloud-based software for businesses, such as a Software-as-a-Service (SAAS) application.

### Other Use Cases

In some embodiments, the concepts and methods described herein can be used in situations beyond the transportation of goods. For example, the method and system described above can be used to route drivers or travelers via low-risk routes that have a fewer number of car accidents (e.g., damages reported to cars as a result of pavement imperfections, wild animals, traffic violations), fewer incidents of dangerous driving, etc. In this case, records from insurance companies and/or police reports can serve as historical records used to track KPIs and other metrics, calculate odds ratios, and derive risks and CRS associated with each road segment as described above. Higher risk road segments can be penalized and/or road segments with lower risk can be rewarded. Further, road segments above a predetermined CRS threshold can be penalized as described above. By way of example and not limitation, insurance companies can use this method to reward with discounts the drivers who elect to choose low risk routes.

Another use case can be data, audio, video and other file and information connection routing through multi-computer and multi-server based networks. For example, network connections are made from point A to point B based, primarily, on network traffic. However, there may be some connection hubs which are notoriously slow, and when used, the network connection is poor or interrupted (e.g., during a video call or during live streaming). Therefore, if there are records that show networks and their behavior when connections are made through them (e.g., number of fast connections, number of slow connections, number of interruptions, etc.), one can use the method described herein to assess which networks are most likely to cause a poor connection when selected. For example, the method described herein could track KPIs, calculate odds ratios (e.g., bad connections versus good connections, slow connections versus fast connections, network interruption versus no interruption, and the like) for its network and derive a CRS for each network segment (much like road segments). Thus, the method described herein can penalize high-risk networks (much like high-risk roads), reward low-risk networks (much like low-risk roads), or propose a network connection (much like a route) not only based on network traffic but also on connection quality (e.g., with a lower risk of a poor connection). Consequently, the same principles described above would apply and low-risk network connection routes would be favored over high-risk network connections.

Based on the above, the concepts described herein are not limited to transport applications and can be equally applied to other fields that involve determining risk associated with connections (e.g., routes) made between an origin point and a destination point, and subsequently suggesting connections or routes that mitigate risk.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated and described with the figures above. Modules may constitute either software modules (e.g., code embodied on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, include processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that includes a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or Bis satisfied by any one of the following: A is true (or present) and Bis false (or not present), A is false (or not present) and B is true (or present), and both A and B are true (or present).

In addition, use of the “a” or “an” are employed to describe elements and components of the embodiments herein. This is done merely for convenience and to give a general sense of the claimed invention. This description should be read to include one or at least one and the singular also includes the plural unless it is obvious that it is meant otherwise.

Upon reading this disclosure, those of skill in the art will appreciate still additional alternative structural and functional designs for the system described above. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for mitigating routing risks during transport of goods, the method comprising:
obtaining historical records for transported goods, wherein the records comprise routes with associated road segments;
establishing risk metrics for each road segment on each route based on the historical records;
calculating, from the risk metrics, road risk and road probability metrics respectively for each road segment on each route;
applying a weight to each of the road risk and road probability metrics;
combining, for each road segment on each route, the weighted road risk and road probability metrics for such road segment into a composite risk score (CRS) that defines whether such road segment is low-risk or high-risk for transporting goods; and
selectively adjusting a length of each road segment defined as low-risk and/or each road segment defined as high-risk based on its corresponding CRS.

2. The method of claim 1, further comprising providing routing suggestions that favor low-risk road segments.

3. The method of claim 1, wherein the records comprise dates for each route completed, road segments used for each route, and damage reports filed for transported goods in each route.

4. The method of claim 1, wherein selectively adjusting the length of each road segment defined as low-risk and/or each road segment defined as high-risk comprises increasing the length of high-risk road segments.

5. The method of claim 1, wherein selectively adjusting the length of each road segment defined as low-risk and/or each road segment defined as high-risk comprises reducing the length low-risk road segments.

6. The method of claim 1, wherein selectively adjusting the length of each road segment defined as low-risk and/or each road segment defined as high-risk comprises increasing the length of high-risk road segments when their CRS is above a predetermined threshold.

7. The method of claim 1, wherein establishing the risk metric comprises:
determining whether a claim for damaged goods is filed for a route, wherein the claim comprises a claim amount representing a value of the damaged goods;
in response to determining that the claim is filed for the route, charging an amount equal to the claim amount to a damage account assigned to each road segment in the route;
in response to determining that the claim is not filed for the route, rewarding an amount equal to a value of the transported goods to a damage-free account assigned to each road segment in the route.

8. The method of claim 1, wherein establishing the risk metric comprises:
determining whether a claim for damaged goods is filed for a route, wherein the claim comprises a claim amount representing a value of the damaged goods;
in response to determining that the claim is filed for the route, charging a time-weighted claim amount to a damage account assigned to each road segment in the route;
in response to determining that the claim is not filed for the route, rewarding a time-weighted value of the transported goods to a damage-free account assigned to each road segment in the route.

9. A system for mitigating routing risks during transport of goods, the system comprising:
a server configured to:
receive historical records for transported goods, wherein the records comprise routes with associated road segments;
establish risk metrics for each road segment on each route based on the historical records;
calculate, from the risk metrics, road risk and road probability metrics for each road segment on each route;
apply a weight to each of the road risk and road probability metrics;
combine, for each road segment on each route, the weighted road risk and road probability metrics for such road segment into a composite risk score (CRS) that defines whether such road segment is low-risk or high-risk for transporting goods; and
selectively adjust a length of each road segment defined as low-risk and/or each road segment defined as high-risk based on their corresponding CRS; and
an electronic device communicatively coupled to the server, wherein the electronic device is configured to receive and incorporate the adjusted length of each road segment defined as low-risk and/or each road segment defined as high-risk to its route calculation.

10. The system of claim 9, wherein the electronic device is a GPS unit or a mobile device configured to run GPS navigation applications.

11. The system of claim 9, wherein the records comprise dates for each route completed, road segments used for each route, and damage reports filed for transported goods in each route.

12. The system of claim 9, wherein to selectively adjust the length of each road segment defined as low-risk and/or each road segment defined as high-risk comprises increasing the length of high-risk road segments.

13. The system of claim 9, wherein to selectively adjust the length of each road segment defined as low-risk and/or each road segment defined as high-risk comprises reducing the length low-risk road segments.

14. The system of claim 9, wherein to selectively adjust the length of each road segment defined as low-risk and/or each road segment defined as high-risk comprises increasing the length of high-risk road segments when their CRS is above a predetermined threshold.

15. A computer program product for mitigating routing risks during transport of goods, the computer program product comprising a non-transitory computer-readable medium having computer readable program code stored thereon, the computer readable program code configured to:
receive historical records for transported goods, wherein the records comprise routes with associated road segments;
establish risk metrics for each road segment on each route based on the historical records;
calculate, from the risk metrics, road risk and road probability metrics for each road segment on each route;
apply a weight to each of the road risk and road probability metrics;
combine, for each road segment on each route, the weighted road risk and road probability metrics for such road segment into a composite risk score (CRS) that defines whether such road segment is low-risk or high-risk for transporting goods; and
selectively adjust a length of each road segment defined as low-risk and/or each road segment defined as high-risk road segments based on their corresponding CRS.

16. The computer program of claim 15, wherein the computer readable program code is further configured to provide routing suggestions based on low-risk road segments.

17. The computer program of claim 15, wherein the records comprise dates for each route completed, road segments used for each route, and damage reports filed for each route.

18. The computer program of claim 15, wherein to selectively adjust the length of each road segment defined as low-risk and/or each road segment defined as high-risk comprises increasing the length of high-risk road segments.

19. The computer program of claim 15, wherein to selectively adjust the length of each road segment defined as low-risk and/or each road segment defined as high-risk comprises reducing the length of low-risk road segments.

20. The computer program of claim 15, wherein to selectively adjust the length of each road segment defined as low-risk and/or each road segment defined as high-risk comprises increasing the length of high-risk road segments when their CRS is above a predetermined threshold.
